(19) United States
(12) Patent Application Publication
(10) Pub. No.: US 2013/0069522 A1
(43) Pub. Date: Mar. 21, 2013

(54) WAY OF REDUCING LED'S COLOR TEMPERATURE AND COLOR COORDINATES DRIFTING

(71) Applicants: Ching-Cherng Sun, Yangmei City (TW); Ching-Yi Chen, Taipei City (TW); Hsin-Mei Wu, Kaohsiung City (TW); Cheng-Chien Chen, Yilan City (TW)

(72) Inventors: Ching-Cherng Sun, Yangmei City (TW); Ching-Yi Chen, Taipei City (TW); Hsin-Mei Wu, Kaohsiung City (TW); Cheng-Chien Chen, Yilan City (TW)

(73) Assignee: National Central University, Taoyuan County (TW)

(21) Appl. No.: 13/233,779

(22) Filed: Sep. 15, 2011

(51) Int. Cl. H01J 1/63

(52) U.S. Cl. 313/503

(57) ABSTRACT

The present invention relates to a way of reducing LED's color temperature and color coordinates drifting, more particularly to a phosphor-converted LED with blue ray light emitting body so that the influence of LED's heat dissipation on color performance can be minimized.

### BACKGROUND OF THE INVENTION

1. Field of the Invention

The present invention relates to a way of reducing LED's color temperature and color coordinates drifting, more particularly to a phosphor-converted LED with a blue-ray emitting body so that the influence of LED's heat dissipation on color performance can be minimized.

2. Description of Related Art

Light emitting efficiency of the LED lamp is easily affected by heat, particularly under high power of the electric current for a long time, the color performance becomes unstable and the color temperature increases dramatically. The commercial white LED generally uses one or more than two kinds of phosphors wherein phosphors are affected by heat and change the light color to make LED lamp color unstable. Conventional experience shows that working temperature has critical influence on LED light emitting efficiency and the conventional way of overcoming poor LED light emitting efficiency is to improve LED heat dissipation and to change the LED material so as to reduce influence from heat dissipation.

Light emitting efficiency of the LED lamp is easily influenced by heat, especially under high power of the electric current for a long time, and the result is the unstable color performance and the higher color temperature. Here the inventor proposes a way for reducing LED's color temperature and color coordinates drifting, more particularly, a phosphor-converted LED with a blue-ray emitting body so that the influence of LED's heat dissipation on color performance can be minimized.

### SUMMARY OF THE INVENTION

The main objective of the present invention is to provide a way of reducing LED's color temperature and color coordinates drifting, more particularly to a phosphor-converted LED with a blue-ray emitting body so that the influence of LED's heat dissipation on color performance can be minimized.

To achieve the objective, a way for reducing LED's color temperature and color coordinates drifting comprises a blue-ray emitting body supplemented with a phosphor, the phosphor referring to all phosphors having ability of excitation spectrum (intensity versus wavelength) with zero or positive slope within a wavelength range from 400 to 470 nm, the blue-ray emitting body having a primary wavelength within 400 to 470 nm which are supplemented with the YAG phosphor;

thereby the white LED has less effect on the drifting of the LED color temperature and color coordinates.

Further benefits and advantages of the present invention will become apparent after a careful reading of the detailed description with appropriate reference to the accompanying drawings.

### BRIEF DESCRIPTION OF THE DRAWINGS

FIG. 1 is a schematic diagram of a chromatic performance of blue-ray for showing red shift of PW under heat effect;

FIG. 2 is a schematic diagram of a chromatic performance of converted yellow-ray for showing the intensity of the converted yellow-ray decreasing with the increasing temperature and the red shift of PW under heat effect;

FIG. 3A is a schematic diagram of a phosphor with a proper ability of excitation spectrum;

FIG. 3B is a schematic diagram of a thermal decay of converted yellow-ray;

FIG. 4 is a schematic diagram of white LED chromatic is performance with different concentrations of YAG phosphor within the blue-ray range from 400 to 470 nm;

FIG. 5 is a schematic diagram of a chromatic performance for showing the phosphor with higher ability of excitation spectrum not to balance the thermal decay of converted yellow-ray;

FIG. 6 is a schematic diagram of a chromatic performance for showing the phosphor with proper ability of excitation spectrum to balance the thermal decay of converted yellow-ray; and

FIG. 7 is a schematic diagram of a chromatic performance for showing the phosphor with lower ability of excitation spectrum not to balance the thermal decay of converted yellow-ray.

### DETAILED DESCRIPTION OF THE INVENTION

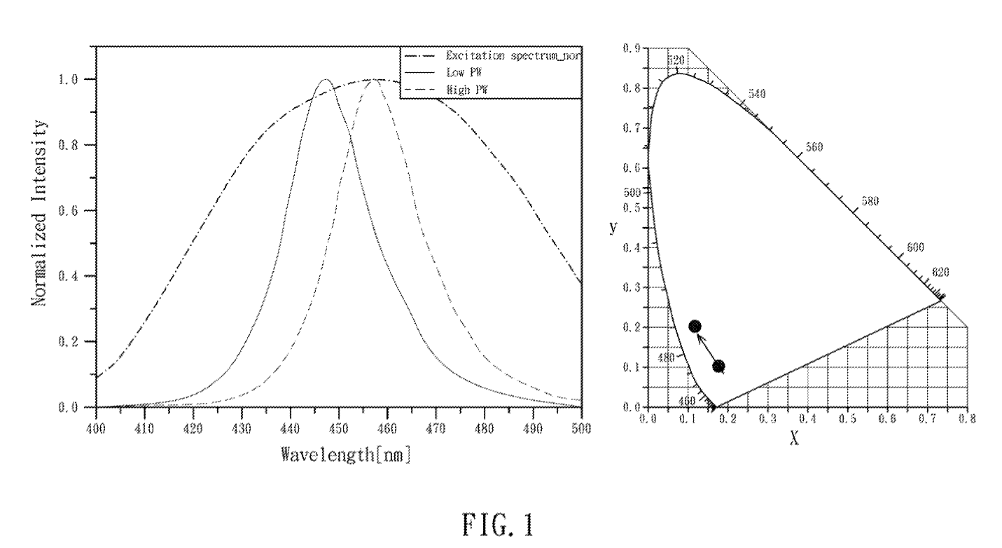

Referring to the drawings and initially to FIGS. 1 to 7, a way of reducing the LED's color temperature and color coordinates drifting comprises a result based on the following physical characteristics:

a redistribution of a blue-ray spectrum under thermal effect, the red shift of the PW (peak wavelength) of the blue-ray, different absorption of blue-ray, the conversion of the yellow-ray, the change of CCT (correlated to color temperature) and the color coordinates drifting. After thousands of experiments, we show that the phosphor-converted LED with a blue-ray emitting body between a wavelength range from 400 to 470 nm have comparatively less effect for LED's color temperature and color coordinates drifting.

This wavelength range is applicable for all phosphors with an ability of excitation spectrums (intensity versus wavelength) which have the feature of zero or positive slope under this wavelength range.

Furthermore, the phosphor is the YAG (Yttrium aluminium garnet) phosphor in the present invention.

In FIG. 1, PW (peak wavelength) occur red shift with the temperature increasing, such as the Low PW being shifted to the High PW.

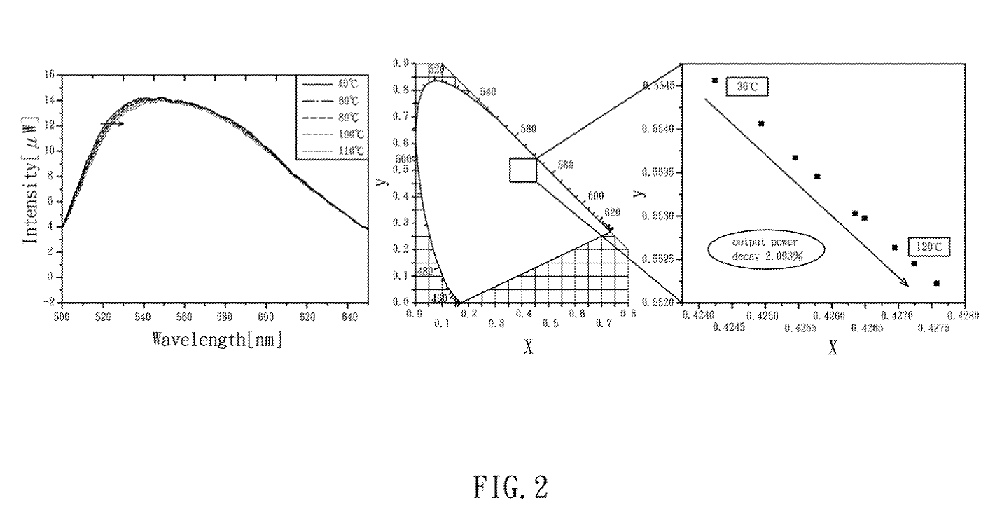

In FIG. 2, the quantum behavior of the phosphor decreases with the temperature increasing. Specifically, a converted yellow-ray decreases (or so-called thermal decay), and a converted yellow-ray spectrum occurs red shift, too. Consequently, B/Y (the ratio of blue-ray and converted yellow-ray) decreases and CCT (correlated color temperatures) increases.

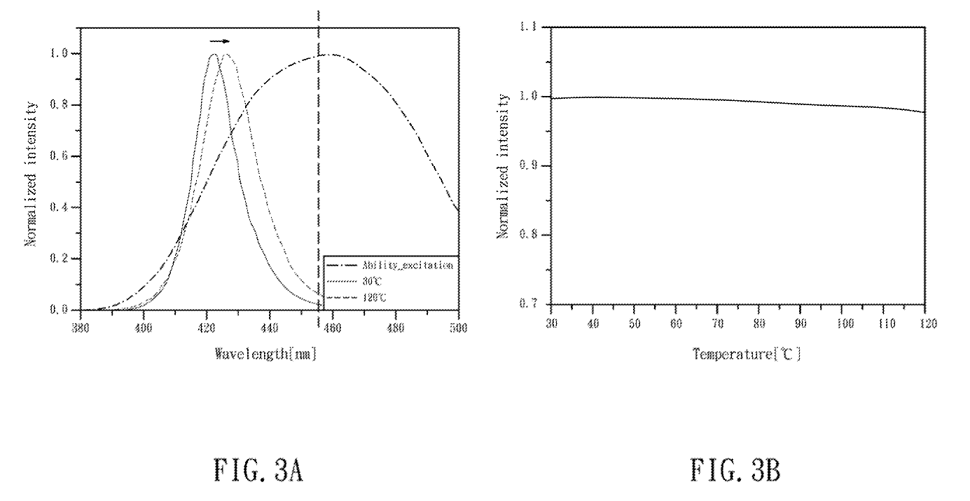

FIG. 3A is to adjust the blue-ray spectrum with one phosphor which has a proper ability of excitation spectrum for converting the yellow-ray; FIG. 3B is the intensity decreasing of the converted yellow-ray with the increasing temperature. In order to get one balance condition between FIG. 3A and 3B, when the blue-ray emitting body has primary wavelength within 400 to 470 nm supplemented with some proper phosphors, such as YAG phosphor, the color coordinates drifting can be minimized.

Relevant formulas are defined as following:

$${Power}_{total} = \int {P}_{barechip} ( λ ) d λ$$

$${P}_{barechip N} ( λ ) = \frac{{P}_{barechip} ( λ )}{{Power}_{total}}$$

$$Excitation ability = \int {P}_{excitation} ( λ ) {P}_{barechip N} ( λ ) d λ$$

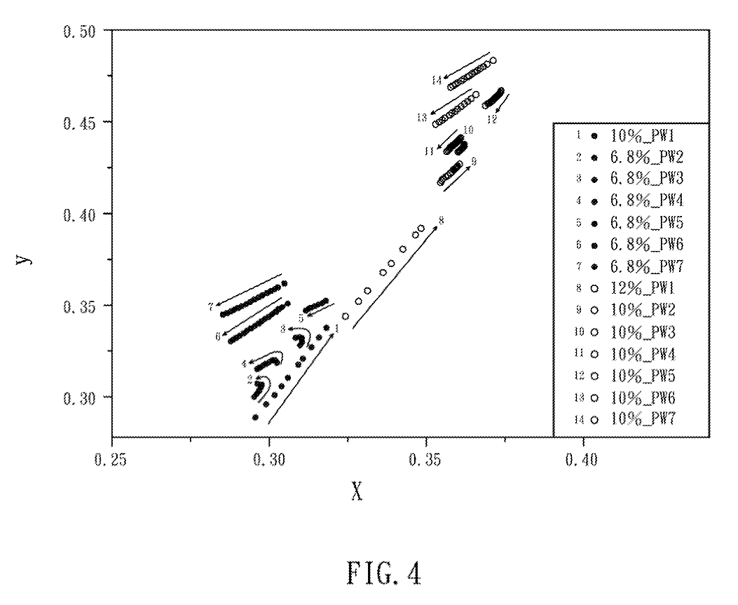

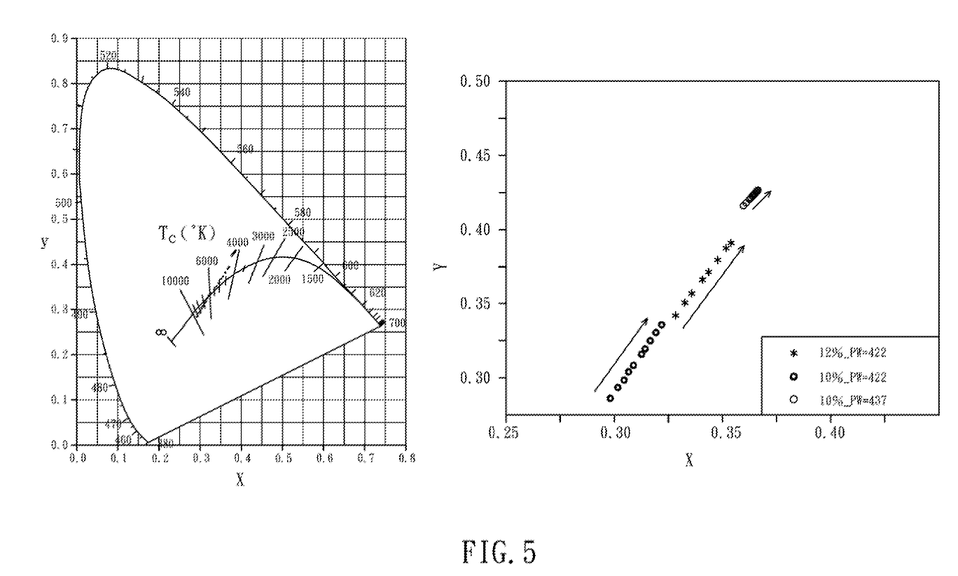

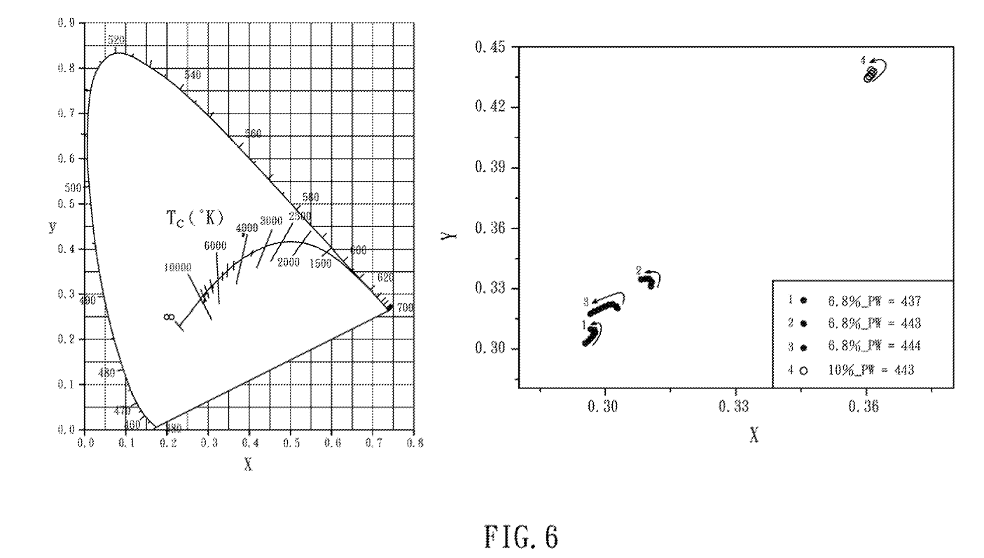

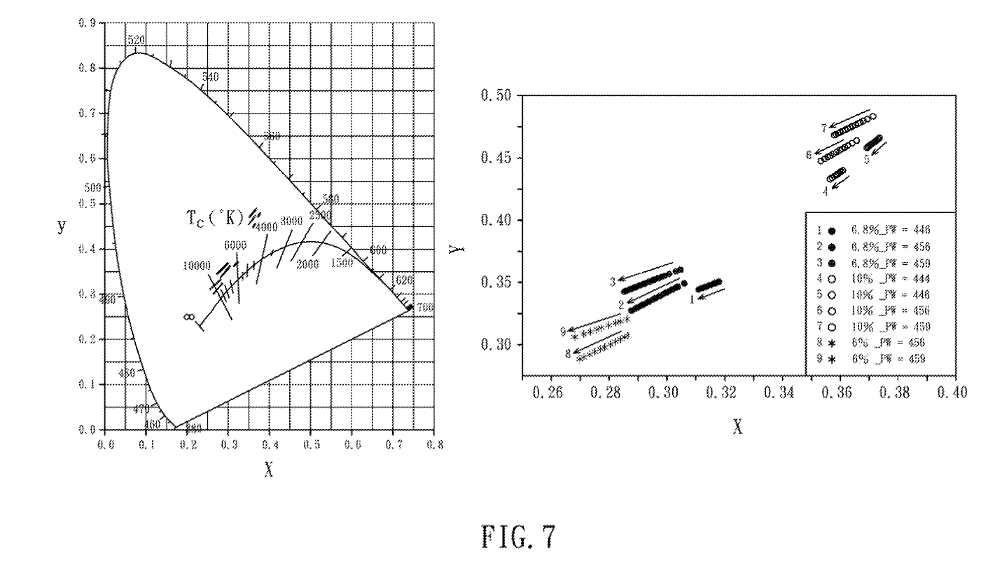

However, different concentrations of the phosphor might get worse white light performance. Referring to FIG. 4, we also show the white light performance with different concentrations of YAG phosphor within the blue-ray range from 400 to 470 nm. The concentrations effect is tiny within the blue-ray range from 400 to 470 nm when the balance condition is achieved. We further offer the experimental result of three situations in support of our discovery: (A) the phosphor with higher ability of excitation spectrum not to balance the thermal decay of converted yellow-ray as shown in FIG. 5; (B) the phosphor with proper ability of excitation spectrum to balance the thermal decay of converted yellow-ray as shown in FIG. 6; (C) the phosphor with lower ability of excitation spectrum not to balance the thermal decay of converted yellow-ray as shown in FIG. 7.

Although the invention has been explained in relation to its preferred embodiment, it is to be understood that many other possible modifications and variations can be made without departing from the spirit and scope of the invention as hereinafter claimed.

What is claimed is:

1. A way for reducing LED's color temperature and color coordinates drifting comprising a blue-ray emitting body supplemented with a phosphor, the phosphor referring to all phosphors having excitation spectrum (intensity versus wavelength) with zero or positive slope within a wavelength range from 400 to 470 nm, the blue-ray emitting body having a primary wavelength within 400 to 470 nm which are supplemented with the phosphor;
thereby the white LED has less effect on the drifting of the LED color temperature and color coordinates.

2. The way for reducing LED's color temperature and color coordinates drifting as claimed in claim 1, wherein the phosphor is YAG phosphor.
